(19) United States
(12) Patent Application Publication
(10) Pub. No.: US 2024/0304896 A1
(43) Pub. Date: Sep. 12, 2024

(54) ACTIVE HYDRAULIC ELEMENT IN A BATTERY MODULE FOR AN ELECTRIC VEHICLE

(71) Applicant: FCA US LLC, Auburn Hills, MI (US)

(72) Inventors: Tae Hyun Kim, Troy, MI (US); Daniel E. Hornback, Davisburg, MI (US); Oliver Gross, Oxford, MI (US)

(21) Appl. No.: 18/178,884

(22) Filed: Mar. 6, 2023

(51) Int. Cl. H01M 10/6568; H01M 10/48

(52) U.S. Cl. CPC H01M 10/6568; H01M 10/486

(57) ABSTRACT

A system includes a battery module with a plurality of walls having a first end wall spaced apart from a second end wall. A plurality of battery cells disposed between the first end wall and the second end wall. The system also includes an inlet module pump communicating dielectric fluid into the battery module into a space between the battery cells and the walls. A compressible element is disposed adjacent to at least one of the plurality of battery cells and has an element wall and an element pump communicating dielectric fluid from the space into the compressible element. The system also includes a pressure sensor generating a pressure signal indicative of the pressure within the battery module. The system also includes a controller coupled to the inlet module pump and the element pump and the pressure sensor, said controller configured to control a pressure within the compressible element based on the pressure signal.

### FIELD

The present disclosure relates to a battery module system and, more particularly, to an immersive cooling environment have a compressible element with the battery module.

### BACKGROUND

This section provides background information related to the present disclosure which is not necessarily prior art.

Electric vehicles rely on battery cells bundled into one or more battery modules to power the vehicle. The battery cells increase the temperature and pressure inside the battery module housing during use. As long as the temperature and pressure-build up remains within a tolerable range, the battery cells can continue to operate. To operate efficiently, the temperature and pressure across the battery modules should be operated within a very close range.

Cell technology is ever-changing. Newer technologies beyond lithium ion change over the course of their life. For example, some newer cell technologies swell and contract during cycling. New cells may also change dimension during their life.

In order to monitor the status of battery cells and/or a battery module, electric vehicle power systems may include temperature sensors to monitor temperatures associated with the battery modules and/or battery cells. Such systems are typically used to detect runaway conditions in a battery module.

### SUMMARY

This section provides a general summary of the disclosure, and is not a comprehensive disclosure of its full scope or all of its features.

The present disclosure provides a system that provides for immersive cooling using a compressible element that is filled with the same fluid used for cooling the battery cells module to accommodate swelling and contraction of the battery cells during operation. Any potential leak of dielectric fluid from the compressible element mixes with the same dielectric fluid that is disposed around the compressible element and therefore does not manifest itself outside of the battery module.

A system of one or more computers can be configured to perform particular battery management operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a system that includes a battery module with a plurality of walls, said plurality of walls may include a first end wall spaced apart from a second end wall; a plurality of battery cells disposed between the first end wall and the second end wall. The system also includes an inlet module pump communicating dielectric fluid into the battery module into a space between the battery cells and the plurality of walls; a compressible element disposed adjacent to at least one of the plurality of battery cells, said compressible element having an element wall and an element pump communicating dielectric fluid from the space into the compressible element. The system also includes a pressure sensor generating a pressure signal indicative of the pressure within the battery module. The system also includes a controller coupled to the inlet module pump and the element pump and the pressure sensor, said controller configured to control a pressure within the compressible element based on the pressure signal. Other embodiments of this aspect include corresponding computer systems, apparatus, and computer programs recorded on one or more computer storage devices, each configured to perform the actions of the methods.

Implementations may include one or more of the following features. The system where the pressure sensor is disposed within the compressible element and generating a signal corresponding to a pressure within the compressible element. The pressure sensor is disposed in the space and the pressure signal corresponding to a pressure within the space. The controller is configured to control a temperature within the battery module in response to a temperature signal by controlling flow through the inlet module pump. The element may include a pressure relief valve communicated dielectric fluid into the space when a pressure within the compressible element is above a relief pressure. The plurality of walls further may include an outlet fluidically coupled to a heat exchanger. The compressible element is disposed between a first battery cell and a second battery cell of the plurality battery cells. The system may include a second compressible element disposed between a third battery cell and a fourth battery cell of the plurality of battery cells. The compressible element is disposed between a first cell of the plurality of battery cells and the first end wall.

The system may include a second compressible element disposed between a second end wall and a second battery cell of a plurality of battery cells. The plurality of battery cells may include a spacer therebetween. Implementations of the described techniques may include hardware, a method or process, or computer software on a computer-accessible medium.

One general aspect includes a method of controlling a battery module having a plurality of walls. The method also includes communicating dielectric fluid into a space between the battery cells and the plurality of walls from outside the battery module with an inlet module pump. The method also includes controlling a pressure within the compressible element based on a pressure signal from within the battery module using an element pump coupled to the compressible element communicating the dielectric fluid thereinto. Other embodiments of this aspect include corresponding computer systems, apparatus, and computer programs recorded on one or more computer storage devices, each configured to perform the actions of the methods.

Implementations may include one or more of the following features. The method may include generating the pressure signal from a pressure sensor disposed within the compressible element. The method may include generating the pressure signal from a pressure sensor disposed in a space between the battery cells and the plurality of walls. The method may include controlling a temperature within the module in response to a temperature signal by controlling flow through the inlet module pump. The method may include relieving pressure from the compressible element with a relief valve by communicating dielectric fluid into the space when the compressible element pressure is above a relief pressure. The method may include positioning the compressible element between a first battery cell and a second battery cell of the plurality battery cells.

The method may include positioning the compressible element between a second compressible element between third battery cell and a fourth battery cell of the plurality of battery cells. The method may include positioning the compressible element between a first cell of the plurality of battery cells and the first end wall. Implementations of the described techniques may include hardware, a method or process, or computer software on a computer-accessible medium.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagrammatic view of a high voltage battery within a vehicle.

FIG. 2A is an example of a battery module within the high voltage battery of FIG. 1 as controlled by the battery conditioning system and the battery management system with a compressible element in a first position.

FIG. 2B is a diagrammatic view of a battery module having two compressible elements at the end of the battery module in a second example.

FIG. 2C is a diagrammatic view of a third example of a battery module having a compressible element in the middle thereof.

FIG. 2D is a fourth example of a battery module having two compressible elements disposed in central locations of the battery cells.

FIG. 3 is a flowchart of a method for operating the battery management system to control the pressure within the battery module.

Corresponding reference numerals indicate corresponding parts throughout the several views of the drawings.

### DETAILED DESCRIPTION

Example embodiments will now be described more fully with reference to the accompanying drawings.

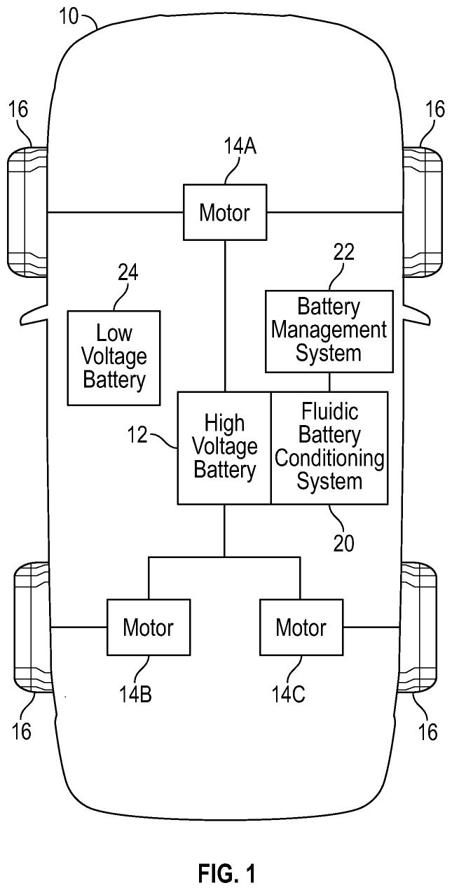

Referring now to FIG. 1, a schematic block diagram of a vehicle 10 is illustrated. The vehicle 10 is adapted to include various features not illustrated such as a passenger compartment mounted thereon.

The vehicle 10 is an electric vehicle that has high voltage battery 12 that is used to power one or more electric motors 14A, 14B and 14C. The electric motors 14A, 14C, 14C are used to provide motive force to the vehicle wheels 16. The number of motors within an electric vehicle may vary. Each of the wheels 16 may have their own motor associated therewith. As shown in the rear of the vehicle 10, each wheel has an electric motor 14B, 14C. One motor 14A is used to power the wheels at one end of the vehicle. The motors 14B and 14C power individual wheels 16.

A fluidic battery conditioning system 20 is used for controlling the temperature and pressure within the high voltage battery 12. A battery management system 22, in communication with the fluidic battery conditioning system and any sensors associated with the high voltage battery, is used to control the operation of the fluidic battery conditioning system 20 as described in more detail below. The battery management system 22 is a microprocessor-based controller programmed to perform various steps sed in the operation of the system.

The vehicle 10 also includes a low voltage battery 24 that has a voltage less than the high voltage battery 12. Examples for the low voltage battery 24 include but are not limited to a 12 volt or 48 volt battery. An example of a high voltage battery 12 is 400 volts plus or minus 50 volts.

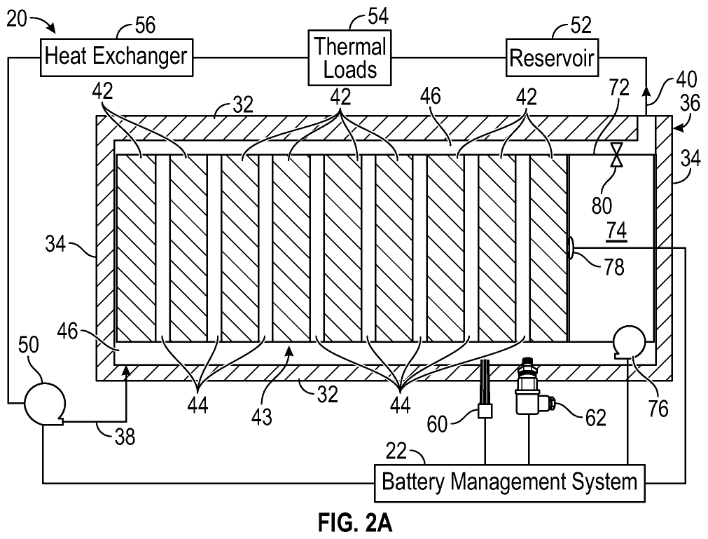

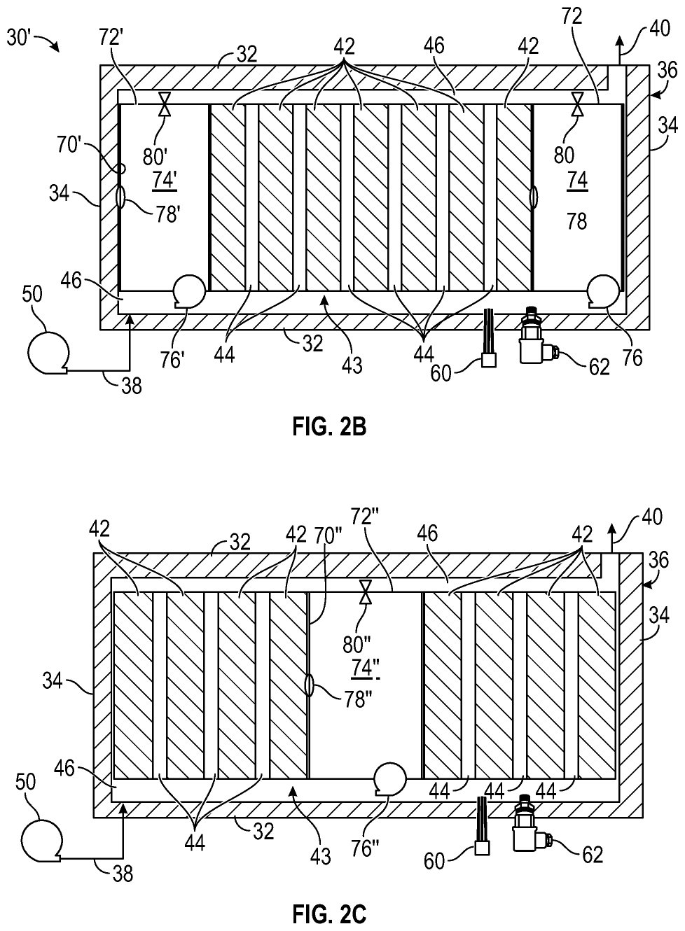

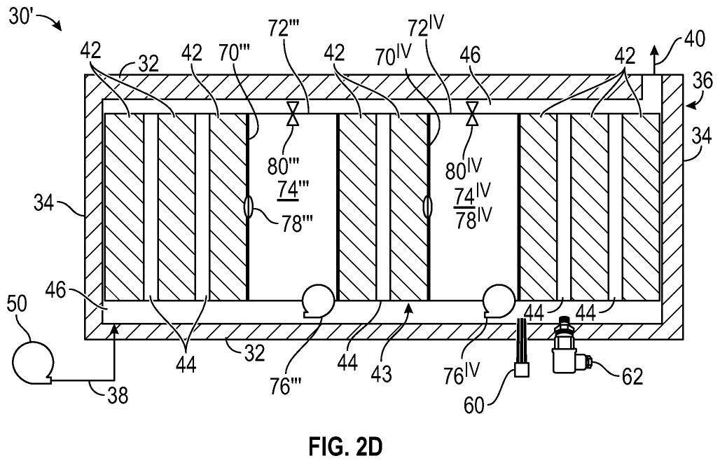

Referring now to FIG. 2A, a battery module 30 representing one battery module of a plurality of battery modules 30 provided within the high voltage battery 12 is illustrated in FIG. 1. The battery module 30 is formed from longitudinal sides 32, which in this example are parallel. End walls 34 are parallel and coupled to the longitudinal sides 32. In the present example, the longitudinal sides 32 and the end walls 34 (and a cover wall and floor wall, not shown) form a rectangular solid that forms a housing 36. At least one of the longitudinal sides 32, the end walls 34, the cover or the floor of the housing 36 have a fluid inlet 38 and a fluid outlet 40 so that dielectric fluid is passed into and out of the housing 36. A plurality of battery cells 42 are disposed within the housing 36. The battery cells 42, in this example, are parallel to the end walls 34 and perpendicular to the longitudinal walls 32. Of course, other configurations are available. Spacers 44 are disposed between the battery cells 42. The spacers 44 are formed of foam in this example. The spacers 44 are therefore compressible.

The battery cells 42 are positioned within the housing so that a space 46 allows the dielectric fluid to flow from the inlet 38 to the outlet 40.

The fluidic battery conditioning system 20 of FIG. 1 includes an inlet module pump 50 that communicates the dielectric fluid in and around the battery cells 42 and through the space 46 within the housing 36. After the fluid is communicated to the space 46 and the housing 36, the outlet 40 communicates fluid to a reservoir 52. The reservoir 52 communicates dielectric fluid to other thermal loads 54 and the heat exchanger 56 to cool the dielectric fluid before the heat exchanger 56 communicates the dielectric fluid to the pump 50. The thermal loads 54 and the reservoir 52 are optional features.

It is desirable to compress the plurality of battery cells 42. The battery cells 42 are referred to as a stack 43. Because the housing 36 is sealed, a minimal amount of pressure is provided at the housing 36 in known systems. For examples, 0.4 bar is typically provided. However, a significantly greater amount of pressure for the battery cells 42 is desirable under certain conditions for various types of battery cells. For example, more than three bars of pressure may be desired for operating. The pressure in the battery module 30 may be varied based on swelling of the battery cells 42. Pre-compression stack systems are susceptible to a larger fluctuation in pressure during operation.

A temperature sensor 60 generates a temperature signal that corresponds to the temperature of the dielectric fluid within the space 46. The temperature sensor 60 thus provides data that corresponds to the temperature of the battery cells 42. The battery management system 22 increases or decreases the speed of the pump 50 based upon the temperature as determined using the temperature signal of the temperature sensor 60.

A pressure sensor 62 generates a pressure signal having pressure data that corresponds to the pressure within the housing 36.

A compressible element 70, in this example, is disposed between a battery cell 42 and one of the end walls 34. The compressible element 70, in this example, is has an element wall formed of a flexible film 72. The flexible film 72 encloses a variable volume 74 therein. A flexible film 72 allows a differential pressure to exist between the volume 74 at least temporarily during operation.

The compressible element 70 has an element pump 76 that communicates the dielectric fluid from the space 46 into (or out of) the flexible film wall 72 and therefore the compressible element 70. The element pump 76 is coupled to battery management system 22 which controls the speed thereof.

The compressible element 70 has a pressure sensor 78 associated therewith. The pressure sensor 78 generates a pressure signal that corresponds to the pressure within the compressible element 70 and the volume 74 enclosed therein. The pressure sensor 78 or the pressure sensor 62 is used to determine the amount to pressurize the battery cells. Although the pressure sensor 78 provides the pressure within the housing 36, a direct correlation can be made between the output of the pressure sensor 78 and the pressure within the housing 36. Therefore, only one pressure sensor 78, in this example, is used to provide pressure feedback to the battery management system 22. Calibration during development of manufacturing can correlate the pressure signal of the pressure sensor 78 with the pressure in the battery module.

A relief valve 80 relieves the pressure within the volume 74 should the pressure be above a relief pressure.

Although only one battery module 30 is illustrated, a number of battery modules are provided in a vehicle system that are configured in a similar way.

Referring now to FIG. 2B, another example of a battery module 30′is illustrated. In this example, a second compressible element 70′ is illustrated at a second end of the housing. That is, the second compressible element 70′ is located between a second end wall 34 and one of the battery cells 42. The second compressible element 70 includes a flexible film wall 72′, the volume 74′, an element pump 76′, a pressure sensor 78′ and a relief valve 80′. The pressure sensor 78′ and the element pump 76′ are in communication with the battery management system 22 as described above relative to FIG. 2A. Thus, the pressure of battery cells 42, in this example, is controlled using two compressible elements 70 and 70′ as controlled by the battery management system 22.

Referring now to FIG. 2C, the compressible element and the features associated therewith of FIG. 1 is located between two battery cells 42 somewhere in the middle of the battery stack 43. The compressible element 70″ has the flexible film wall 72″, that encloses the volume 74″ and has an element pump 76″ to communicate the dielectric fluid from the space 46 to the volume 74 within the compressible element. The pressure sensor 78″ provides a pressure signal to the battery management system. A relief valve 80 relieves the pressure within the volume 74 should the pressure be too high.

Referring now to FIG. 2D, two compressible elements 70′″, 70^{iv}. The compressible elements 70′″, 70^{iv} are positioned spaced apart from each other but within the battery stack 43 away from the end walls 34. The compressible elements 70′″, 70^{iv} have flexible film walls 72′″, 72^{iv} that defined respective volumes 74′″, 74^{iv.} Element pumps 76′″, 76^{iv} are operated by the battery management 22 based upon the pressure from the pressure sensor 78′″, 78^{iv.} Release valves 80′″, 80^{iv} provide relief from within the respective volumes 74′″, 74^{iv} should the pressure exceed that which is desirable.^{.}

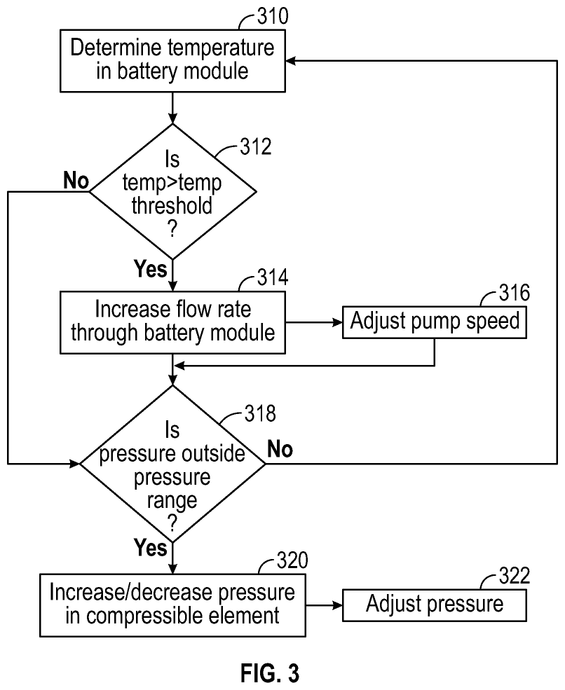

Referring now to FIG. 3, a method for operating the system is set forth. In step 310, the temperature in the battery module 30 is determined based upon the temperature sensor 60 illustrated in FIG. 2A. The temperature signal from the temperature sensor is communicated to the battery management system 22 that determines the temperature within the battery module. If the temperature in the battery module is greater than a temperature threshold in step 312, step 314 controls the increase in the flow rate through the battery module in step 314 by adjusting the speed of the inlet module pump 50 in step 316.

After step 312 when the temperature is below the threshold and after step 316, step 318 is performed. If the pressure determined by the battery management system 22 from the pressure sensor 62 or 78 (of FIG. 2A) indicates that the pressure of the battery cells is outside of a pressure range, step 320 increases or decreases the pressure within the compressible element by controlling the element pump 76 and/or one of the pumps 76′, 76″, 76′″, and 76^{iv}.

Ultimately the pumps are controlled by the battery management system in response to the feedback from one of the pressure sensors 78 (or the pressure sensors (78′, 78″, 78′″, and/or 78^{iv}) which are indicative of the pressure in the battery module.

In step 318 if the pressure is not outside the pressure range, step 310 is performed again. This allows the system to be continuously monitored.

Thus, the feedback from the battery management system 22 can increase or decrease the pressure in the volume 74 of the compressible element 70.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways.

Such variations are not to be regarded as a departure from the disclosure, and all such modifications are intended to be included within the scope of the disclosure.

What is claimed is:

1. A system comprising:
a battery module by a plurality of walls, said plurality of walls comprising a first end wall spaced apart from a second end wall;
a plurality of battery cells disposed between the first end wall and the second end wall;
an inlet module pump communicating dielectric fluid into the battery module into a space between the battery cells and the plurality of walls;
a compressible element disposed adjacent to at least one of the plurality of battery cells, said compressible element having an element wall and an element pump communicating dielectric fluid from the space into the compressible element;
a pressure sensor generating a pressure signal indicative of the pressure within the battery module; and
a controller coupled to the inlet module pump and the element pump and the pressure sensor, said controller configured to control a pressure within the compressible element based on the pressure signal.

2. The system of claim 1 wherein the pressure sensor is disposed within the compressible element and generates a signal corresponding to a pressure within the compressible element.

3. The system of claim 1 wherein the pressure sensor is disposed in the space and the pressure signal corresponding to a pressure within the space.

4. The system of claim 1 wherein the controller is configured to control a temperature within the battery module in response to a temperature signal by controlling flow through the inlet module pump.

5. The system of claim 1 wherein the element comprises a pressure relief valve communicated dielectric fluid into the space when a pressure within the compressible element is above a relief pressure.

6. The system of claim 1 wherein the plurality of walls further comprises an outlet fluidically coupled to a heat exchanger.

7. The system of claim 1 wherein the compressible element is disposed between a first battery cell and a second battery cell of the plurality battery cells.

8. The system of claim 7 further comprising a second compressible element disposed between a third battery cell and a fourth battery cell of the plurality of battery cells.

9. The system of claim 1 wherein the compressible element is disposed between a first cell of the plurality of battery cells and the first end wall.

10. The system of claim 9 further comprising a second compressible element disposed between a second end wall and a second battery cell of a plurality of battery cells.

11. The system of claim 1 wherein the plurality of battery cells comprises a spacer therebetween.

12. A method of controlling a battery module having a plurality of walls, said plurality of walls comprising a first end wall spaced apart from a second end wall, said battery module comprising a plurality of battery cells disposed between the first end wall and the second end wall, said battery module further comprising a compressible element disposed adjacent to at least one of the battery cells, said compressible element having an element wall and an element pump, said method comprising
communicating dielectric fluid into a space between the battery cells and the plurality of walls from outside the battery module with an inlet module pump; and
controlling a pressure within the compressible element based on a pressure signal from within the battery module using an element pump coupled to the compressible element communicating the dielectric fluid thereinto.

13. The method of claim 12 further comprising generating the pressure signal from a pressure sensor disposed within the compressible element.

14. The method of claim 12 further comprising generating the pressure signal from a pressure sensor disposed in a space between the battery cells and the plurality of walls.

15. The method of claim 12 further comprising controlling a temperature within the module in response to a temperature signal by controlling flow through the inlet module pump.

16. The method of claim 12 further comprising relieving pressure from the compressible element with a relief valve by communicating dielectric fluid into the space when the compressible element pressure is above a relief pressure.

17. The method of claim 12 further comprising positioning the compressible element between a first battery cell and a second battery cell of the plurality battery cells.

18. The method of claim 17 further comprising positioning the compressible element between a second compressible element between third battery cell and a fourth battery cell of the plurality of battery cells.

19. The method of claim 17 further comprising positioning the compressible element between a first cell of the plurality of battery cells and the first end wall.

20. The method of claim 17 further comprising positioning a second compressible element between a second end wall and a second battery cell of a plurality of battery cells.
